(19) United States
(12) Patent Application Publication
(10) Pub. No.: US 2015/0310451 A1
(43) Pub. Date: Oct. 29, 2015

(54) VEHICLE DRIVER TRACKING AND REPORTING

(71) Applicant: Ford Global Technologies, LLC, Dearborn, MI (US)

(72) Inventors: Keith Michael PLAGENS, Northville, MI (US); James Michael LENOX, Northville, MI (US); Laurie Elizabeth WOJAN, Novi, MI (US)

(73) Assignee: Ford Global Technologies, LLC, Dearborn, MI (US)

(21) Appl. No.: 14/264,902

(22) Filed: Apr. 29, 2014

(51) Int. Cl. G06Q 30/00; G01G 19/44; G06Q 50/26

(52) U.S. Cl. CPC G06Q 30/018; G06Q 50/26; G01G 19/44

(57) ABSTRACT

Various structures and methods are described herein to track driving of a restricted driver. In an example, an additional criterion is also tracked, which can be an authorized driving supervisor in the vehicle. This criterion is separate from the driving data and is used to meet the requirements of a licensing agency. The criterion can be the presence of a licensed driver in the vehicle, e.g., in the front passenger seat, with the restricted driver. The vehicle can use its onboard sensors and computing system to determine that a licensed driver is supervising the driving of the restricted driver.

### TECHNICAL FIELD

Various embodiments relate to tracking a vehicle and a driver.

### BACKGROUND

Vehicles have implemented greater computing power over the years. This on-vehicle computing power can be used to track vehicle performance.

U.S. Pat. No. 8,306,739 describes a system and a method for tracking locations for one of a primary driver and a secondary driver. The apparatus comprises a communication module configured to receive a driver status signal indicative of the driver being the secondary driver. The communication module is further configured to detect the presence of a memory map device that provides map data for one or more locations capable of being visited by the secondary driver and to receive a location signal having coordinate data that corresponds to one or more locations visited by the secondary driver. The communication module is further configured to store the coordinate data when the memory map device is not detected so that the coordinate data is available for transmission with the map data when the memory map device is detected.

### SUMMARY

Various structures and methods are described herein to track driving of a restricted driver. An additional criterion is also tracked. This criterion is separate from the driving data and is used to meet the requirements of a licensing agency. The criterion can be the presence of a licensed driver in the vehicle, e.g., in the front passenger seat, with the restricted driver. The vehicle can use its onboard sensors and computing system to determine that a licensed driver is supervising the driving of the restricted driver.

A method for tracking driving and sensing a criterion can include identifying a restricted vehicle driver, tracking driving data of the identified driver, wherein driving data includes driving time, identifying an authorized driving supervisor in a vehicle, and sending driving-data and the identified authorized driving supervisor to a remote device.

In an example, identifying an authorized driving supervisor includes sensing, using a seat sensor, a presence of a passenger in a passenger seat of the vehicle.

In an example, sensing the presence of the passenger includes sensing the weight of the passenger to determine that the sensor is sensing a weight threshold for an adult driving supervisor.

In an example, identifying an authorized driving supervisor includes receiving an identifier to identify the passenger and confirming that driving time by the identified driver qualifies for state driving license requirement.

In an example, identifying a vehicle driver includes identifying a restricted driver.

In an example, tracking driving performance includes tracking driving time, time of day, time of week, and road type.

A vehicle system is described that can perform any of the above methods. A vehicle system can include an identification module to identify a restricted vehicle driver, first sensing circuitry to track driving data of the identified driver, wherein driving data includes driving time, second sensing circuitry to identify an authorized driving supervisor in a vehicle, and communication circuitry to send a signal based on the sensed driving data and the identified authorized driving supervisor to a remote device.

In an example, the second sensing circuitry includes a seat sensor to sense a presence of a passenger in a passenger seat of the vehicle.

In an example, the seat sensor is to sense a weight of the passenger to determine that the sensor is sensing a weight threshold for an adult driving supervisor.

In an example, the second circuitry includes a receiver to receive an identifier to identify the passenger and to confirm that driving time by the identified driver qualifies for a driving license requirement.

In an example, the identification module includes identifying a restricted driver.

In an example, the first circuitry includes timing circuitry to sense driving time, time of day, time of week, or combinations thereof.

In an example, the first circuitry includes circuitry to sense the road type.

The present disclosure further includes non-transitory computer-readable medium including instructions that, when executed by a processor, are configured to perform the methods described herein. The medium can also be part of a vehicle system.

### BRIEF DESCRIPTION OF THE DRAWINGS

FIG. 1 illustrates a vehicle computing system, in an example embodiment.

FIG. 2 illustrates a driver tracking process, in an example embodiment.

FIG. 3 illustrates a driver tracking process, in an example embodiment.

FIG. 4 illustrates a driver tracking process, in an example embodiment.

### DETAILED DESCRIPTION

The present document details embodiments of the present invention herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

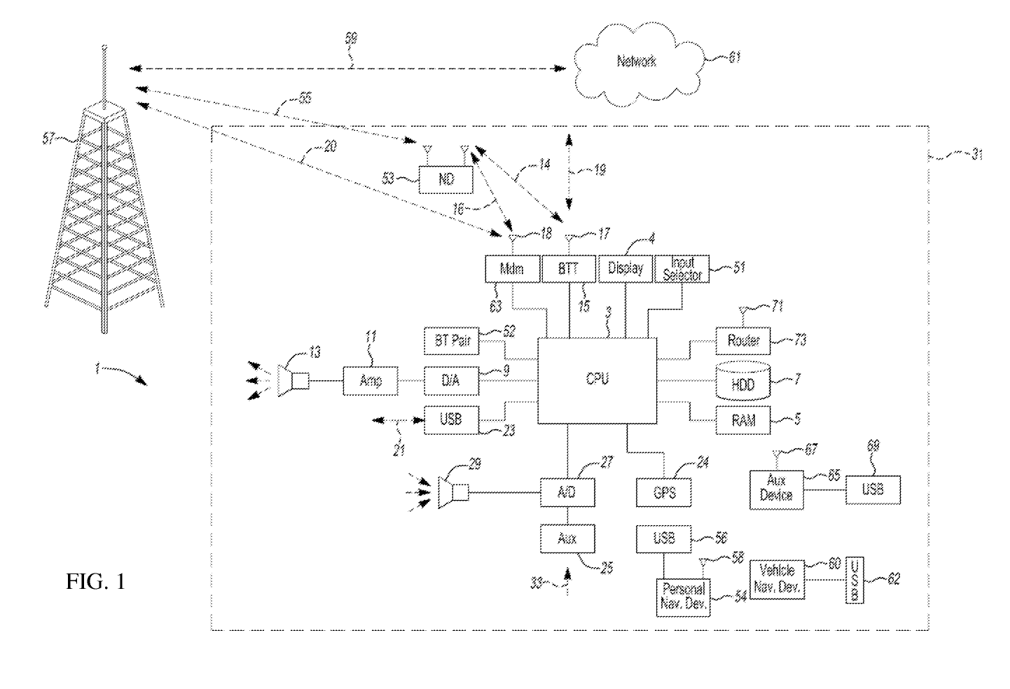

FIG. 1 is an example system for tracking a vehicle and a driver as part of an example block topology for a vehicle based computing system 1 (VCS) for a vehicle 31. A vehicle can be a passenger vehicle, a truck, a motorcycle, a hybrid vehicle, buses, watercraft, aircraft or other conveyances for people. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment shown in FIG. 1, a processor 3 controls at least some portion of the operation of the vehicle-based computing system. Provided within the vehicle, the processor allows onboard processing of commands and routines. A processor can be circuitry that is dedicated to a processing a task and producing a result. The task can be defined by the commands and routines. Once the commands or routines are loaded into the processor's circuitry, the processor becomes a dedicated machine for that task. The result can be stored in memory. The processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a bus input (e.g., a universal serial bus, “USB”) input 23, a positioning unit (e.g., a global positioning system, “GPS”) input 24 and a wireless (e.g., BLUETOOTH, near field, cellular, etc.) input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network, “CAN” bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as a portable navigation device (“PND”) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal data assistant, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the processor, e.g., a CPU, is instructed that the onboard BLUETOOTH transceiver will be paired with a BLUETOOTH transceiver in a nomadic device.

Data may be communicated between processor 3 and network 61 utilizing, for example, a data-plan, data over voice, or dual-tone multi-frequency (“DTMF”) tones associated with nomadic device 53. Alternatively, it may be desirable to include an onboard modem 63 having antenna 18 in order to communicate 16 data between processor (e.g., a central processing unit, programmable logic array, etc.) 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an application programming interface to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN (personal area network). Both are suitable for wireless communication within a vehicle. Another communication means that can be used in this realm is free-space optical communication and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the nomadic device 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the processor could be in communication with a variety of other auxiliary devices 65. These devices can be connected through a wireless 67 or wired connection 69. Auxiliary device 65 may include, but are not limited to, personal media players, wireless health devices, portable computers, and the like.

Also, or alternatively, the processor could be connected to a vehicle based wireless router 73, using for example a WiFi 71 transceiver. This could allow the processor to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes. The VACS and the VCS each include circuitry that can perform steps of processes described herein.

Massive improvements have been made to vehicle connectivity and communication systems over the past few decades. In-vehicle infotainment systems provide remote connectivity, streaming music, customized advertisements, calendar management, hands free calling and a variety of other services. Additionally, automated emergency alerts (e.g., the system calls 911 in the case of a detected accident), vehicle navigation controls and various other connected services can be provided.

Vehicle infotainment systems, such as the Ford SYNC system, connect to wireless devices to obtain remote connectivity and access to applications running on the devices. Also, applications may be specifically developed for interfacing with a vehicle.

With all of these current systems and connectivity solutions, the in car and out of car experiences tend to be compartmentalized into their own environments. Vehicular interaction begins when a user enters a vehicle and ends when the user leaves the vehicle. User activity outside the vehicle is not combined with vehicular information.

In the illustrative embodiments, a seamless interaction between intra and extra vehicular activity is presented. Information from vehicular systems and relating to vehicle states, vehicular application interaction and other information can be passed to wireless device to continue an in-vehicle experience after a user leaves the vehicle. The wireless device can then perform a range of services based on the information, such as reminders, navigation and user updates. Then, when the user returns to the vehicle, further connectivity and information transfer updates the vehicle with the extra-vehicular activity. This information can be integrated into existing applications to improve the user experience. In an example, the wireless device, which can be a mobile phone, can store the data related to driving by a restricted driver and the additional criterion that may be required by a licensing agency. The wireless device can also provide reminders to the restricted driver about due dates for completing certain licensing requirements. These requirements can be loaded into the wireless device using an application, e.g., software instructions downloaded to the phone for executing by the processing circuitry of the wireless device.

In the illustrated examples, the vehicle systems, and possibly VACS, will validate and track the vehicle usage of a driver. In an example the driver is a student driver or a driver with restricted driving privileges. The validation can include a criterion separate from validating the driver and the actual driving sensed by the vehicle systems. The criterion can include, for example, sensing the presence of a person monitoring the driving performance of the student driver. The criterion can be established by sensing the presence of a person in the front passenger seat. In an example, the passenger is confirmed as an eligible person to monitor the student driver as required by various licensing entities.

As an example, a licensing entity may have a scheme with multiple licensing levels, e.g., three licensing levels for the beginning or student driver. Level one of this scheme is a supervised learner's license, which requires a licensed driver over a certain age, e.g., eighteen years of age, to supervise the actual driving of the student driver. Level one can also restrict the hours of driving by the restricted driver. In an example, the driving time restriction can be from 11:00 pm to 5:00 am. Level two of this scheme is an intermediate license that limits passengers (e.g., number and/or age of passenger restrictions) and unsupervised nighttime driving. In another example, the level two requires supervised nighttime driving. In an example, the restricted driver must have at least fifty hours of supervised driving practice with at least ten hours of supervised nighttime driving. Level three of this scheme is a full-privilege driver's license issued after a student driver has successfully completed all previous instruction and driving requirements. That is, the requirements for moving from lower, restricted licensing levels to unrestricted licensing levels have been met. The vehicle, as described herein, can determine the level of driver and report the driving as needed to a licensing agency or store the driving data for monitoring by a parent, responsible adult or others.

License levels one and two have certain restrictions to limit a student driver's exposure to high-risk situations and help protect them while they are learning to drive. The examples described herein can track the actual driving time of the student driver and that the student driver is doing so under at least one other criterion. For a level one, the criterion is that the driver is supervised by a licensed driver that meets the supervisor role as set forth by the licensing entity. Examples of an approved supervisor include a parent, a legal guardian, a licensed driver about a set age, or a trained driving instructor. The vehicle can also sense whether the vehicle is being operated at night. Nighttime driving can be requirement to move from level one licensure to level two licensing or from level two to level three licensing.

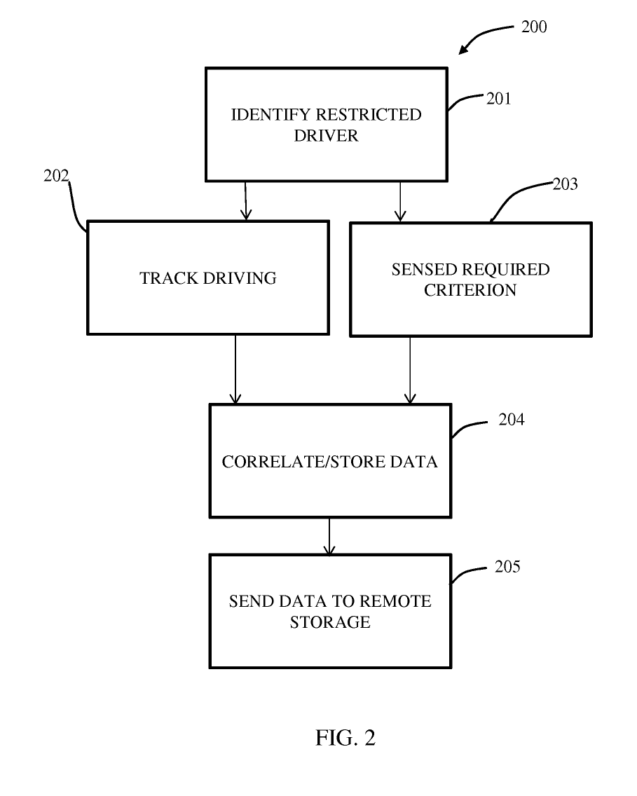

FIG. 2 shows an illustrative process 200 for tracking a driver and operation of the vehicle. Process 200 can provide for driving tracking and includes an additional criterion separate from driving. The criterion is determined by the requirements of the licensing agency. At 201, a restricted vehicle driver is identified. The driver can be identified through the use of an interface with the vehicle computing devices or other circuitry. The driver can sign up with the vehicle system by entering personal identifying information including, but not limited to, name, address, status with licensing agency (e.g., a state department of motor vehicles), age, password, and user name. This driver may be associated with a particular electronic device that communicates directly with the vehicle systems, e.g., a key fob, portable electronic device, phone, smart phone or tablet computing device. In an example, the electronic device is a radio frequency identification (RFID) device that is issued by licensing agency to the driver. This electronic device can be linked to the licensing agency by programming an identifier, e.g., a driver license number or other individual alphanumeric sequence, into the electronic device. In an example, the electronic device has an individual identifier that identifies it to the vehicle. The driver identifier can be programmed into the vehicle computing system or a vehicle associated computing system. The driver identifier can also include a person identification number or password to provide greater security.

At 202, the vehicle tracks the driving of identified driver. The tracked information can include the driving time, the type of road (e.g., highway, local roadways, interstates, tollways, residential roads, etc.), and the driving environment. The driving environment can include the time of day, e.g., daytime or nighttime. The vehicle can use its onboard sensors to determine nighttime driving conditions, e.g., using an ambient light sensor. The driving environment can include the road conditions, e.g., dry or wet, paved or unpaved. The driving environment can also include the weather, e.g., raining, sunny, overcast, cloudy, fog, etc. The vehicle can have a satellite positioning sensor that interacts with the positioning system to determine the location of the vehicle. These vehicle locations can be determined using vehicle location devices, e.g., a global positioning system such as GPS (North America), Russian Global Navigation Satellite System (GLONASS), the European Union's Galileo positioning system, India's Indian Regional Navigational Satellite System, China's Compass navigation system and the like. The positioning systems can be augmented by the vehicles own sensors and knowledge of a road map. An example of a road map and the use of different “keys” for different user's is described in U.S. Pat. No. 8,306,739, titled “System and Method for Tracking a Vehicle Based on Driver Status,” which is hereby incorporated by reference for any purpose. However, if the U.S. Pat. No. 8,306,739 conflicts with the present explicit description, the present description controls interpretation. The actual position of the vehicle on the stored road map can be stored as the driving information. The tracked driving statistics for the identified driver can be stored in the memory circuitry of the vehicle computing system. The tracked driving statistics can be stored in memory circuitry remote from the vehicle by electrically transmitting the driving statistics to the remote memory circuitry.

At 203, a criterion is sensed by the vehicle system. The criterion is a requirement set by the driving licensing agency to qualify the student driver's drive time as lawful training. The criterion is separate from driving data. In an example, the criterion is that the student driver must be accompanied by another driver, e.g., an adult, a licensed driver or a specifically authorized driver. The vehicle can sense that another adult is in the vehicle. The sensing of the supervising adult can be a sensor in the seat to determine that an adult is occupying a vehicle seat, e.g., the front passenger seat. The sensor can also be a sensor that detects the presence of a mobile electronic device in the vehicle that is registered to the driver that is qualified to supervise the restricted driver, e.g., a student driver. The registration of the mobile device can be done by pairing the device to the vehicle's computing system or communication system. The sensor can also include a facial recognition sensor that senses the supervisor in the passenger front seat of the vehicle. The criterion can also be a limited number of vehicle occupants in addition to the supervising licensed driver. In an example, a student driver at a beginning level may only be allowed to have the supervising driver in the car. This might not be one of criteria after the driver has reached another level of licensure or has reached a set number of qualified driving hours. The criteria can also include only daytime hours count toward completing an initial level of licensure. In an example, a restricted driver, e.g., a level one licensed driver, may not be allowed to drive between the hours of 11:00 pm and 5:00 am. Accordingly, driving between these hours does not count toward the licensing agency's required hours of driving practice. Additional criteria that can be tracked by the vehicle are discussed herein. The criteria can be loaded into the vehicle in the form of instructions that can be executed by an electronic device. The instructions are stored in memory circuitry. The instructions can be executed by processing circuitry in the vehicle. When processing circuitry is loaded with the instructions, the circuitry becomes a dedicated machine for those instructions.

At 204, the driving data from operation 202 and the sensed criteria from operation 203 are stored in memory circuitry in the vehicle. The driving data and sensed criteria are correlated together. The correlation can be done on the vehicle using its electronic processing. In a further example, the raw data of the driving data and the sensed criteria are off loaded by vehicle system, operation 205. The offloading can be a transmission through a bus or wirelessly by electronic communications to a computing system remote from the vehicle. The remote computer system can correlate the driving data and the further criterion or further criteria. Then the requirements of the licensing agency can be applied to the correlated data. A report based on the correlated driving data and the criterion can be send to the licensing agency.

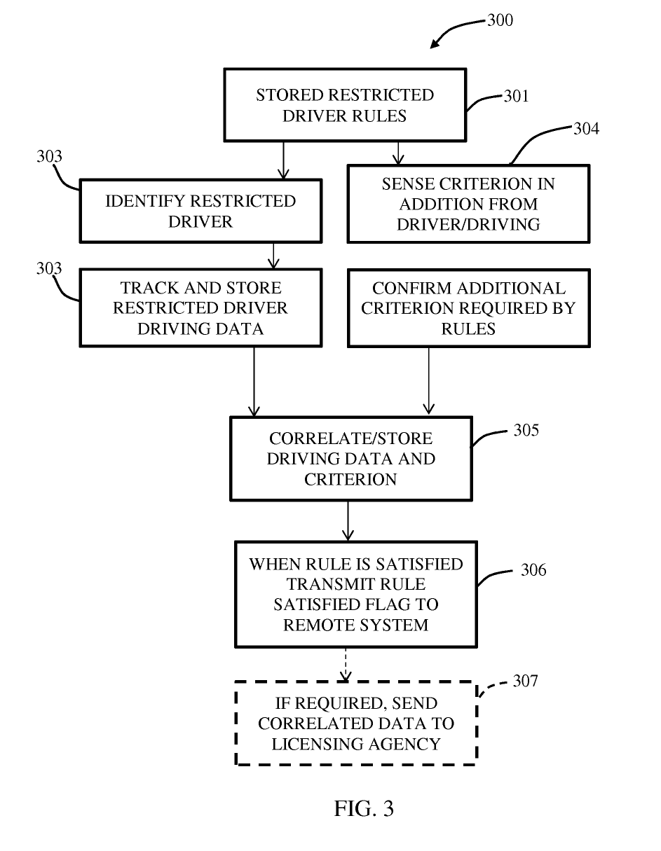

FIG. 3 shows an illustrative process 300 for tracking a driver including, identification of the driver, a non-driving criterion and driver's operation of the vehicle. At 301, the driver is identified. The driver can be identified using an electronic device, interaction with the vehicle system, e.g., through a graphical user interface, or through a bio-sensor, e.g., fingerprint, image sensor, iris scan, vein pattern recognition, etc. At 303, the driver's operation of the vehicle is stored. The driver's operation can include data for driving time, time of day, day of week, daytime driving, nighttime driving, speed, road maps, road type or combinations thereof. At 304, the vehicle system confirms that an additional criterion is being met. In an example, the vehicle system senses the additional criterion. This criterion is separate from driving operation data. In an example, the criterion is a requirement by the licensing agency for the driving of a student driver or restricted driver to qualify for a full license or move from a restricted license to a less-restricted driver's license. In an example, the criterion can be a licensed driver in the vehicle to supervise the restricted driver. The criterion can be met by sensing that a passenger is in the from passenger seat. Sensors can sense that a certain weight is in the seat. The sensors can also include image sensors that confirm that the weight in the passenger seat is a person. The passenger can also be required to enter identifying information into the vehicle system, e.g., the driver's license number of the passenger. This can be used to verify that a licensed supervisor is in the vehicle with the restricted driver as may be required by the licensing agency.

At 305, the sensed driving data and the additional criterion are correlated together. This correlation can be used to validate that the driving being done is within the criteria set by the licensing agency.

At 306, the rules stored in the vehicle system are applied to the driving data and the criterion. If the rule is satisfied, then a signal of satisfaction of the rule can be sent to a computing system separate from the vehicle. In an example, a flag that a rule has been met can be transmitted electronic through a communications network to the licensing agency computer system. The flag can provide proof that the restricted driver has met a requirement for licensing before that agency.

At 307 an optional operation of sending the correlated driving data and the criterion can be performed. This data can be transmitted over a communications network to an off vehicle memory circuitry. The driver, the supervisor or the licensing agency may have access to the data stored off vehicle.

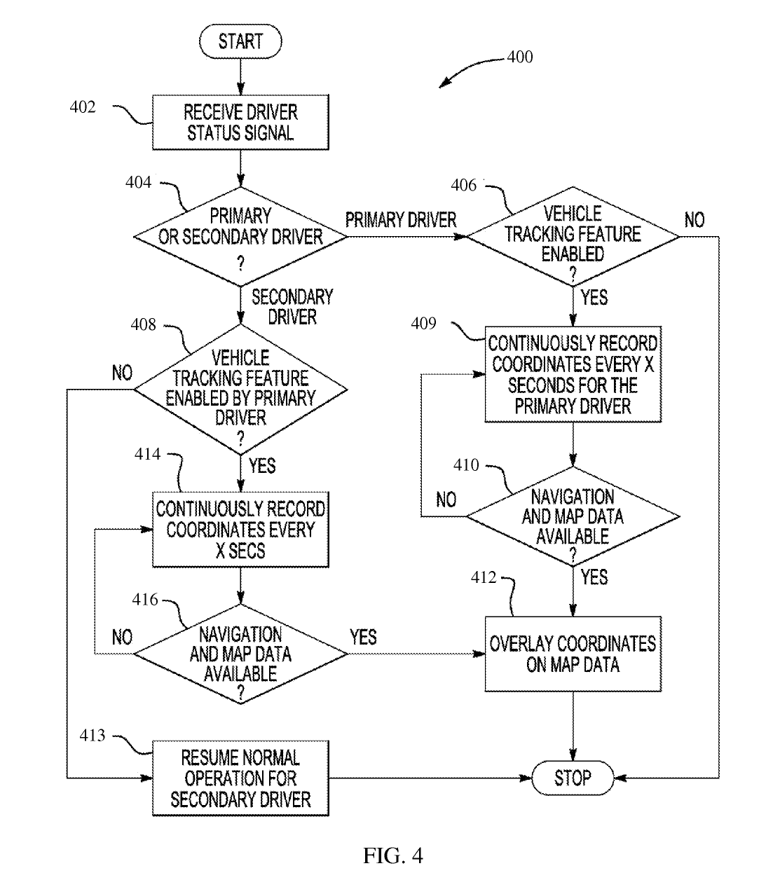

FIG. 4 depicts a method 400 for tracking the location of the vehicle based on the status of the driver in accordance to one embodiment of the present invention.

At 402, the vehicle system receives the signal indicating that a driver has entered the vehicle. The signal can be a signal from a passive entry passive start (PEPS) controller, passive anti-theft security (PATS) controller, an entry on the vehicle's graphical user interface, driver seat sensor, fingerprint sensor, electronic device detector or synchronization device or other vehicle entry sensing system.

At 404, the circuitry in the vehicle system determines whether the driver of the vehicle is a primary driver or a secondary, tracked driver based on the data contained on the driver entry signal. A secondary driver is a restricted driver. The primary driver is an individual who does not need to report his or her driving records to the state licensing agency. Typically, the primary driver is a fully licensed driver under the requirements of the applicable driving licensing governmental authority. Additional information, for example, a personal identification or other tracked driver identifying information may be entered into the vehicle system. If the circuitry detects that the driver is a primary driver, then the method 400 moves to operation 406. If the circuitry detects that the driver is a tracked driver, then the method 400 moves to operation 408.

At 406, the circuitry in the vehicle system determines whether the vehicle tracking feature is enabled. For example, the vehicle system receives a tracking control signal to determine whether the primary driver has enabled the vehicle tracking feature for the primary driver. If the vehicle tracking feature is enabled, the method 400 moves to operation 409. The primary driver may enable the tracking feature so that the primary driver can use the recorded location information in the event that he/she gets lost or would prefer navigation features based on location. The primary driver can use the recorded information as a means of recalling where a particular location is located in the event the driver intends to travel to this location in the future. Particularly, if the recorded location is a new location not visited or rarely visited by the primary driver. If the vehicle tracking feature is disabled, the method 400 moves to the end state.

At 409, the vehicle system receives and stores the location data provided on the location signal(s) at all times irrespective of whether the memory map device is operably coupled to other vehicle sub-systems. For example, a global navigation positioning system can provide all of the coordinates that correspond to locations visited by the primary driver to the other vehicle systems.

At 410, the vehicle system determines whether the memory map subsystem is operably coupled therewith so that the location data can be overlaid on top of the map data provided by the memory map subsystem. If the memory map subsystem is not available, the method 400 remains in at 410. If the memory map subsystem is available, the method 400 moves to operation 412.

At 412, the vehicle system overlays the location coordinates received by the location signal on the map data provided by the memory map subsystem for presentation to the primary driver via one or more of the options discussed above in connection with FIG. 1. The data presented in operation 412 is indicative of the locations visited by the primary driver. This data can be stored locally in the memory of vehicle or downloaded to the external electronic device(s) of the primary driver. However, this data is not reported to the licensing agency or used to qualify the student driver for further licensing.

At 408, processes for tracking the student driver are begun. The vehicle system determines whether the vehicle tracking feature is enabled and dedicated to a specific student driver. For example, the primary driver may have enabled this feature so that the vehicle system tracks the locations visited by the tracked driver. Further, the primary driver can enable the vehicle systems to download the licensing requirements for the student driver. The vehicle can then track those driving action that qualify the student driver for further licensing. The vehicle can also implement, by executing rules stored in software, the prohibitions established by the licensing agency for the student driver. Examples of prohibitions can include the number of people in the vehicle, the time of day, distance restrictions among others. The tracked driver is not capable of de-activating this feature if set by the primary driver. If the vehicle tracking feature is disabled for the secondary driver by the primary driver, then the method 400 moves to operation 413. If the vehicle tracking feature is enabled for the secondary driver by the primary driver, then the method 400 moves to operation 414.

At 413, the communication subsystem is structured to receive a control signal to activate the tracking of the student driver. In an example, the primary driver can send the control signal to the vehicle system for a remote communication device, e.g., computer, tablet or phone, to activate the vehicle's tracking feature for the student driver. In this example, the secondary (e.g., student or restricted) driver cannot deactivate the tracking as it was enable by the primary driver. In another example, the student driver can enable the tracking feature for himself/herself via his/her device or through the vehicle interface. The secondary driver may want to enable the feature in the event the primary driver has not yet enabled the tracking feature or there is more than one student driver and enabling by the student driver allows individual tracking. The tracking can also provide the ability to recall a location that was visited and the driving route. In one example, the travel data can be presented on the display and may include a unique color to identify the recorded locations for the secondary driver. In yet another example, the vehicle may not display the recorded locations for display to the primary driver (or wireless transmission/downloading to portable memory device to primary driver). Such a condition may provide some degree of privacy for the secondary driver.

At 414, the vehicle system receives and stores the location data provided on the location signal at all times irrespective of whether the memory map subsystem is operably coupled to other vehicle subsystems. The position of the vehicle is continuously recorded, e.g., sampled every X seconds. The use of speed and direction can be used to supplement the positioning data from satellite systems. For example, the global navigation and positioning subsystem provides all of the coordinates that correspond to driving location visited by the student driver to the vehicle system.

At 416, the vehicle system determines whether the memory map subsystem is operably coupled therewith so that the location data can be overlaid on top of the map data provided by the memory map subsystem, which map data can be stored on circuitry, e.g., on a memory map memory circuitry. If the map data is not available, the method 400 moves back to operation 414. If the map data is available, the method 400 moves to operation 412.

At 412, the vehicle system overlays the location coordinates received on the map data provided by the memory circuitry of the vehicle system for presentation to the primary driver and/or the secondary driver via one or more of the options discussed above in connection with FIG. 1, and presentation of the student driver data to the licensing agency. In an example, secondary driver data presented in operation 412 is indicative of meeting the requirements, stored as rules in instructions to be executed by a computing device, e.g., the vehicle systems, off-vehicle computer, smart phone or dedicated electronic device for executing the instructions. The secondary driving data includes at least one criteria in additional to the driving data. The criteria can include a supervisor in the vehicle, e.g., a licensed driver in the passenger seat. The criteria can include no night time driving. The criteria can include a certain number of day-time driving hours before the system will log nighttime hours.

In a further example, the criterion is the non-use of a mobile device while driving. The processes and systems described herein can track the driving data for a restricted driver. The electronic communications of the restricted driver's mobile device can be correlated with the driving data. If an electronic communication is initiated by the wireless device during the driving time, that driving data is invalidated or flagged to not meet the requirements of the licensing agency. In another example, if an electronic communication, e.g., a text message, Tweet, email, telephone call is opened, read, or answered during the driving time, then the restricted driver is reported to the licensing agency and the driving data for that time is not accepted by the licensing agency.

The present description may use the term “module” and words of similar import to describe substructures of the computing systems. Modules include hardware, in the form of circuitry, and may include software, in the form of instructions stored in memory and executable by circuitry and processors. The term “circuitry” and words of similar import can include processors, memory, programmable logic arrays, application specific integrated circuits, integrated circuits, discrete components and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Although various embodiments may have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method comprising:
identifying a restricted driver;
tracking driving-data identified restricted driver identified restricted driver, wherein driving-data includes driving time;
identifying an authorized driving supervisor in a vehicle; and
sending driving-data and the identified authorized driving supervisor to a remote device.

2. The method of claim 1, wherein identifying an authorized driving supervisor includes sensing, using a seat sensor, a presence of a passenger in a passenger seat of the vehicle.

3. The method of claim 2, wherein sensing the presence of the passenger includes sensing weight of the passenger to determine that the sensor is sensing a weight threshold for an adult driving supervisor.

4. The method of claim 2, wherein sensing a required criterion includes receiving an identifier to identify the passenger and confirming that driving time by the identified driver qualifies for state driving license requirement.

5. The method of claim 4, wherein identifying a vehicle driver includes identifying a restricted driver.

6. The method of claim 5, wherein tracking driving performance includes tracking driving time, time of day, time of week, and road type.

7. The method of claim 1, wherein identifying an authorized driving supervisor includes identifying a mobile device associated with the authorized driving supervisor or identifying the authorized driving supervisor using facial recognition.

8. A vehicle system comprising:
an identification module to identify a restricted vehicle driver;
first sensing circuitry to track driving data of the restricted driver, wherein driving data includes driving time;
second sensing circuitry to identify an authorized driving supervisor in a vehicle; and
communication circuitry to send a signal based on the sensed driving data and the identified authorized driving supervisor to a remote device.

9. The system of claim 8, wherein the second sensing circuitry includes a seat sensor to sense a presence of a passenger in a passenger seat of the vehicle.

10. The system of claim 9, wherein the seat sensor is to sense a weight of the passenger to determine that the sensor is sensing a weight threshold for an adult driving supervisor.

11. The system of claim 8, wherein the second circuitry includes a receiver to receive an identifier to identify a passenger and to confirm that driving time by the identified driver qualifies for a driving license requirement.

12. The system of claim 11, wherein the identification module includes identifying a restricted driver.

13. The system of claim 12, wherein the first circuitry includes timing circuitry to sense driving time, time of day, time of week, or combinations thereof.

14. The system of claim 12, wherein the first circuitry includes circuitry to sense road type.

15. The system of claim 8, wherein the second sensing circuitry include at least one of a mobile communication sensor, a facial recognition sensor or combinations thereof.

16. A non-transitory computer-readable medium including instructions that, when executed by a processor, are configured to perform a method comprising:
identifying a restricted driver;
tracking driving-data identified restricted driver, wherein driving-data includes driving time;
identifying an authorized driving supervisor in a vehicle; and
sending driving-data and the identified authorized driving supervisor to a remote device.

17. The medium of claim 16, wherein identifying an authorized driving supervisor includes sensing, using a seat sensor, a presence of a passenger in a passenger seat of the vehicle.

18. The medium of claim 17, wherein sensing the presence of the passenger includes sensing a weight of the passenger to determine that the sensor is sensing a weight threshold for an adult driving supervisor.

19. The medium of claim 17, wherein sensing a required criterion includes receiving an identifier to identify the passenger and confirming that driving time by the identified driver qualifies for state driving license requirement.

20. The medium of claim 16, wherein identifying an authorized driving supervisor includes identifying a mobile device associated with the authorized driving supervisor or identifying the authorized driving supervisor using facial recognition.
